(19) United States
(12) Patent Application Publication
(10) Pub. No.: US 2024/0227790 A9
(43) Pub. Date: Jul. 11, 2024

(54) DRIVING SUPPORT APPARATUS, DRIVING SUPPORT METHOD, AND NON-TRANSITORY COMPUTER-READABLE STORAGE MEDIUM

(71) Applicant: TOYOTA JIDOSHA KABUSHIKI KAISHA, Toyota-shi (JP)

(72) Inventor: Koichi TSUCHIYA, Susono-shi (JP)

(73) Assignee: TOYOTA JIDOSHA KABUSHIKI KAISHA, Toyota-shi (JP)

(21) Appl. No.: 18/482,358

(22) Filed: Oct. 6, 2023

(30) Foreign Application Priority Data
Oct. 19, 2022 (JP) 2022-167565

(51) Int. Cl. B60W 30/09

(52) U.S. Cl. CPC B60W 30/09; B60W 2540/18; B60W 2552/50

(57) ABSTRACT

A driving support apparatus comprises a sensor configured to detect an object, and a controller configured to execute a collision control when the object satisfies a first collision condition. The controller determines whether or not the object satisfies a second collision condition which is more difficult to be satisfied than the first collision condition when both an angle condition and a steering condition are satisfied in a case where the object is a three-dimensional object which is in a roadside or a median strip of a road. The angle condition is a condition that an entry angle formed by a traveling direction of the vehicle and the three-dimensional object is equal to or smaller than a threshold angle. The steering condition is a condition for determining that a driver performs an avoidance steering operation. The controller executes the collision control when the three-dimensional object satisfies the second collision condition.

### TECHNICAL FIELD

The present disclosure relates to a driving support apparatus that executes a collision control for avoiding a collision between an object and a vehicle or reducing a damage caused by the collision when the object satisfies a predetermined collision condition.

### BACKGROUND

Conventionally, a driving support apparatus that executes a collision control has been known. For example, the driving support apparatus described in Patent Literature 1 (hereinafter, referred to as a “conventional apparatus”) does not execute the collision control when the driver performs a turn-back steering operation. The turn-back steering operation is an operation of returning a rotation angle of a steering wheel toward an initial position (a reference position) of the steering wheel after the driver steers(rotates) the steering wheel in one direction. The conventional apparatus acquires a collision possibility that a vehicle collides with an oncoming vehicle while the vehicle is performing a lane change. The oncoming vehicle is a vehicle that is traveling on an oncoming lane which is a lane beyond a lane change destination. The conventional apparatus executes the collision control based on the acquired collision possibility so that the conventional apparatus can reduce a possibility of unnecessarily executing the collision control.
Patent Document 1: Japanese Patent Application Laid-Open No. 2018-154174

### SUMMARY

The collision possibility that the vehicle collides with a three-dimensional object existing on a road side or a median strip of the road may increase. For example, such three-dimensional object is a guardrail, a wall, or the like. Examples where the collision possibility that the vehicle collides with the three-dimensional object increases include a case where the vehicle performs the lane change, a case where the vehicle travels on a curved road, and the like. Under such cases, the conventional apparatus does not execute the collision control when the driver performs the turn-back steering operation. Therefore, the conventional apparatus can reduce the possibility of performing unnecessary collision control. Even if the driver is performing an avoidance steering operation, the conventional apparatus does not execute the collision control when the conventional apparatus determines that the driver is performing the turn-back steering operation. The avoidance steering operation is an operation which the driver performs on the steering wheel in order to avoid the collision with the three-dimensional object.

However, even if the driver performs the avoidance steering operation in order to avoid the collision with the three-dimensional object, it is desirable that the collision control is executed for the three-dimensional object when the collision with the three-dimensional object cannot be avoided by the avoidance steering operation.

The present disclosure has been made to address the above-described problem. In other words, an object of the present disclosure is to provide a driving support apparatus capable of reducing a possibility that the unnecessary collision control for the three-dimensional object existing on the road side or the median strip is executed, and increasing a possibility that the necessary collision control for the three-dimensional object is certainly performed.

The driving support apparatus of the present disclosure (hereinafter, referred to as “the present apparatus”) comprises:
a sensor (22, 24) configured to detect an object; and
a controller (20) configured to execute a collision control for avoiding a collision between a vehicle and the object or reducing a damage caused by the collision (step 435) when the object satisfies a first collision condition (step 425, step 430 “Yes”).

The controller is further configured to:
determine whether or not the object satisfies a second collision condition which is more difficult to be satisfied than the first collision condition (step 460, step 430) when both an angle condition and a steering condition are satisfied (step 445 “Yes”, step 455 “Yes”) in a case where the object is a three-dimensional object which is in a roadside or a median strip of a road on which the vehicle is traveling (step 420 “Yes”), the angle condition being a condition that an entry angle (θ) formed by a traveling direction of the vehicle and the three-dimensional object is equal to or smaller than a predetermined threshold angle (θth), the steering condition being a condition for determining that a driver performs a steering operation for avoiding the collision between the vehicle and the three-dimensional object; and
execute the collision control (step 435) when the three-dimensional object satisfies the second collision condition (step 430 “Yes”).

When the entry angle of the vehicle into the three-dimensional object is larger than the threshold angle, that is, when the angle condition is not satisfied, a possibility that the collision with the three-dimensional object cannot be avoided is high, even if the driver performs a steering operation (an avoidance steering operation) for avoiding the collision with the three-dimensional object. When the driver does not perform the avoidance steering operation, the possibility that the collision with the three-dimensional object cannot be avoided is high, even if the entry angle is equal to or smaller than the threshold angle. Therefore, when the angle condition is not satisfied and/or when the steering condition is not satisfied, the present apparatus of the present disclosure executes the collision control when the first collision condition is satisfied.

On the other hand, when the entry angle is equal to or smaller than the threshold angle, a possibility that the collision with the three-dimensional object can be avoided is high, if the driver performs the avoidance steering operation. Therefore, when both the angle condition and the steering condition are satisfied, the present apparatus of the present disclosure executes the collision control when the second collision condition that is more difficult to be satisfied than the first collision condition is satisfied.

Therefore, according to the present disclosure, it is possible to reduce the possibility that unnecessary collision control for the three-dimensional object is executed, and to increase the possibility that necessary collision control with respect to the three-dimensional object is executed reliably.

### BRIEF DESCRIPTION OF THE DRAWINGS

FIG. 1 is a schematic configuration diagram of a driving support apparatus according to an embodiment of the present disclosure.

FIG. 2 is a diagram for explaining a situation where neither an angle condition nor a steering condition is satisfied.

FIG. 3 is a diagram for explaining a situation where both the angle condition and the steering condition are satisfied.

FIG. 4 is a flowchart of a routine executed by a CPU of the driving support apparatus.

FIG. 5 is a flowchart of a subroutine executed by the CPU of the driving support apparatus.

### DETAILED DESCRIPTION

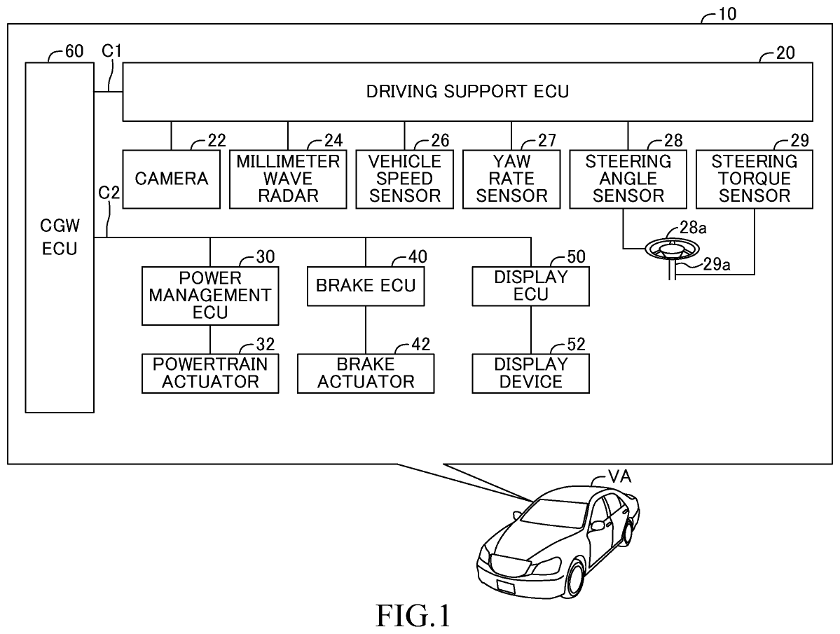

As illustrated in FIG. 1, a driving support apparatus (a support apparatus) 10 according to the embodiment of the present disclosure is applied to a vehicle VA. The support apparatus 10 includes components illustrated in FIG. 1.

A driving support ECU is an ECU that executes a driving support control, and is hereinafter referred to as an “ECU20”.

In the present specification, the “ECU” is an electronic control unit including a microcomputer as a main part. The ECU may be referred to as a controller or a computer. The microcomputer includes a CPU (a processor), a ROM, a RAM, an interface, and the like. Some or all of the ECU20 and the plurality of ECUs described below may be integrated into one ECU.

The camera 22 acquires image data by capturing an image of a scene in front of the vehicle VA. The camera 22 acquires camera object information and white line information based on the image data. The camera object information includes a position of an object located in front of the vehicle VA with respect to the vehicle VA. The white line information includes a position of a white line on a road on which the vehicle VA is traveling with respect to the vehicle VA. The camera 22 transmits the camera object information and the white line information to the ECU20.

The millimeter wave radar 24 transmits a millimeter wave to the front of the vehicle VA. The millimeter wave radar 24 receives a reflected wave of the millimeter wave to acquire radar object information. The reflected wave is the millimeter wave reflected at a reflection point of the object. The radar object information includes “the position of the object with respect to the vehicle VA” and “a relative speed Vr of the object with respect to the vehicle VA”. The millimeter wave radar 24 transmits the radar object information to the ECU20.

A vehicle speed sensor 26 detects a vehicle speed Vs representing a speed of the vehicle VA. A yaw rate sensor 27 detects a yaw rate Yr acting on the vehicle VA. A steering angle sensor 28 detects a rotational angle of a steering wheel 28a from a neutral position as a steering angle θs. When the steering wheel 28a is steered from the neutral position to the left, the steering angle θs becomes a negative value, and when the steering wheel 28a is steered from the neutral position to the right, the steering angle θs becomes a positive value. The steering torque sensor 29 detects a steering torque Tr representing a torque acting on a steering shaft 29a connected to the steering wheel 28a. The ECU20 acquires these detection values.

A power management ECU30 is connected to a powertrain actuator 32. The power management ECU30 controls the powertrain actuator 32. The powertrain actuator 32 changes a driving force generated by a driving device (for example, an internal combustion engine and/or an electric motor) of the vehicle VA. A brake ECU40 is connected to a brake actuator 42 and controls the brake actuator 42. The brake actuator 42 controls a braking force applied to the vehicle VA. A display ECU50 is connected to a display device 52, and displays an alert screen described later on the display device 52. A CGW (control gateway) ECU60 controls transmission/reception of data between the plurality of ECUs via a first communication line C1 and a second communication line C2.

### (Operation)

An operation of the ECU20 of the support apparatus 10 will be described. The ECU20 determines whether or not an object that may collide with the vehicle VA is a road side object (a three-dimensional object) OB (e.g., a guardrail, a wall, etc.). The road side object is present in a road side or a median strip of the road on which the vehicle VA travels.

In a case where the object is not the roadside object OB, the ECU20 executes a collision control when a predetermined first collision condition is satisfied. The ECU20 determines that the first collision condition is satisfied when a TTC (Time To Collision) of the object is equal to or less than a first threshold time T1th. The TTC is a time it takes for a vehicle VA to collide with the object. The ECU20 executes, as the collision control, a deceleration control (a kind of autonomous driving) for controlling the powertrain actuator 32 and the brake actuator 42 such that an acceleration G of the vehicle VA coincides with a predetermined deceleration Gtgt. The acceleration G is a time-derivative of the vehicle speed Vs.

In a case where the object is the roadside object OB, the ECU20 determines whether or not a predetermined second collision condition that is more difficult to be satisfied than the first collision condition is satisfied when both the following “angle condition and steering condition” are satisfied. The ECU20 determines that the second collision condition is satisfied when the TTC is equal to or less than a second threshold time T2th set to be smaller than the first threshold time T1th. In a case where the object is the roadside object OB and at least one of the angle condition and the steering condition is not satisfied, the ECU20 executes the collision control when the first collision condition is satisfied.

### <Angle Condition>

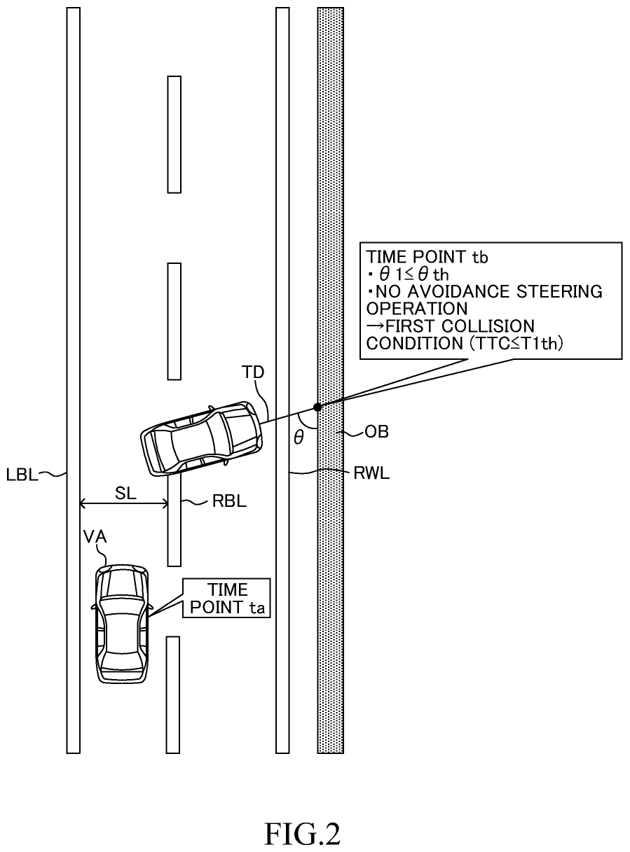

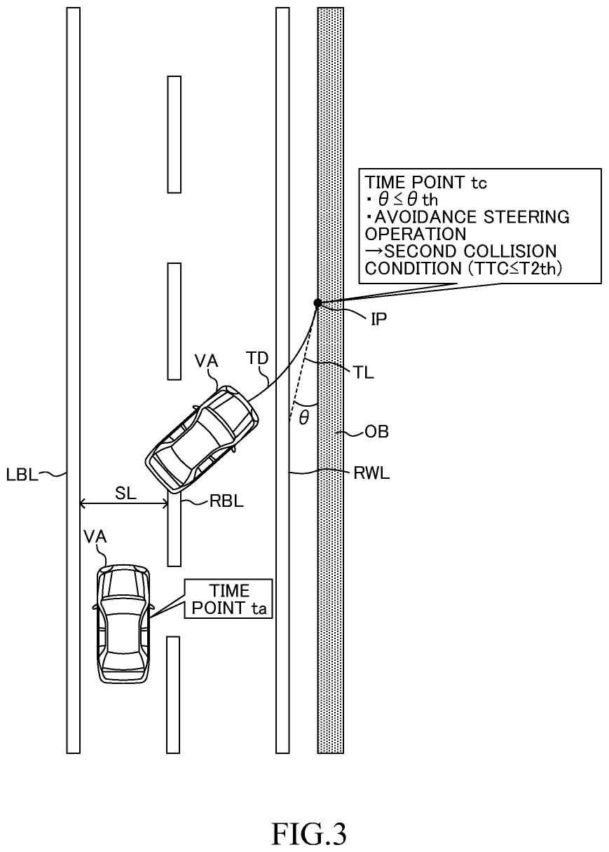

The ECU20 determines that the angle condition is satisfied when an “entry angle (approach angle) θ at which the vehicle VA enters (approaches) the roadside object OB” is equal to or smaller than a predetermined threshold angle θth. The entry angle θ is shown in FIGS. 2 and 3. Specifically, the ECU20 acquires, as the entry angle θ, an angle formed by the “roadside object OB specified based on a detection result of the millimeter wave radar 24” and a traveling direction TD of the vehicle VA. More specifically, the ECU20 acquires, as the entry angle θ, an angle formed by an approximate line of the reflection points and the traveling direction TD. The reflection points are specified based on the detection result of the roadside object OB. The ECU20 acquires the traveling direction TD based on the vehicle speed Vs and the yaw rate Yr.

### <Steering Condition>

When the following conditions 1 to 4 are satisfied, the ECU20 determines that the driver is performing an “avoidance steering operation which is a steering operation for avoiding a collision with the roadside object OB” so as to determine that the steering condition is satisfied.
Condition1: The steering wheel 28a is steered to a direction to avoid colliding with the roadside object OB, that is, to a direction in which the entry angle θ decreases.
Condition 2: A magnitude of the steering angle θs is equal to or greater than a threshold angle θsth.
Condition3: A magnitude of the steering torque Tr is equal to or greater than a threshold torque Trth.
Condition 4: A magnitude of a steering angular velocity ω is equal to or greater than a threshold angular velocity cath.

When both the angle condition and the steering condition are satisfied, a possibility that that the collision with the roadside object OB can be avoided is high. Therefore, in this case, the ECU20 executes the collision control when the second collision condition that is more difficult to be satisfied than the first collision condition is satisfied. This can reduce the possibility that the collision control is erroneously executed.

When the angle condition is not satisfied, even if the driver performs the avoidance steering operation, a possibility that the collision with the roadside object OB cannot be avoided is high, because the entry angle θ is large. When the steering condition is not satisfied, a possibility that the driver is not performing the avoidance steering operation is high. Therefore, a possibility that the vehicle collides with the roadside object OB is high.

Accordingly, in these cases, the ECU20 executes the collision control when the first collision condition is satisfied. This increases the possibility that collision control will be performed certainly.

As described above, the support apparatus 10 can reduce the possibility that the unnecessary collision control for the roadside object OB is executed and can increase the possibility that the necessary collision control for the roadside object OB is certainly executed.

### Operation Example

An operation example of the support apparatus 10 will be described with reference to FIGS. 2 and 3. In the example shown in FIGS. 2 and 3, there is the guard rail on the road side which is on one side of a two lanes road. There is the guard rail on the right side shown in FIGS. 2 and 3.

The ECU20 specifies a left division line LBL and a right division line RBL that divide a lane SL on which the vehicle VA travels based on the white line information. Further, the ECU20 specifies a white line on the outer side of the left division line LBL and the right division line RBL based on the white line information. In the example shown in FIGS. 2 and 3, the ECU20 specifies a right white line RWL further to the right of the right division line RBL.

Based on the camera object information and the radar object information, the ECU20 determines whether or not a “stationary object” is present in a predetermined area centered on each of the left division line LBL, the right division line RBL, and the right white line RWL. The predetermined area is an area in a direction orthogonal to the longitudinal direction of each white line. When the stationary object is present in the predetermined area, the ECU20 specifies the stationary object as the roadside object OB. In the example illustrated in FIGS. 2 and 3, the guardrail is present in the predetermined area centered on the right white line RWL. Therefore, the ECU20 specifies the guardrail as the roadside object OB.

It is assumed that the driver performs a steering operation to the right side in a time point to illustrated in FIGS. 2 and 3.

At a time point prior to a time point tb shown in FIG. 2, the driver returns the steering wheel 28a to the neutral position. At a time point tb shown in FIG. 2, the steering wheel 28a maintains the neutral position. Therefore, the vehicle VA travels straight at the time point tb. The travel direction TD at the time point tb is as shown in FIG. 2. Since the magnitude of the angle (entry angle) θ between the traveling direction TD and the roadside object OB is larger than the threshold angle θth, the angle condition is not satisfied. Further, since the steering wheel 28a maintains the neutral position, the steering condition is not satisfied. Therefore, the ECU20 executes the collision control when the first collision condition is satisfied.

At a time point prior to the time point tc shown in FIG. 3, the driver performs the steering operation to the left side. At the time point tc shown in FIG. 3, the driver performs the steering operation to the left side. Therefore, at the time point tc, the vehicle VA turns leftward, and the traveling direction TD is as shown in FIG. 3. The ECU20 specifies a tangential line TL to the travel direction TD at “an intersection point IP where the traveling direction TD and the roadside object OB intersect”. The ECU20 acquires an angle formed between the tangential line TL and the roadside object OB as the entry angle θ.

It is assumed that the magnitude of the entry angle θ is equal to or smaller than the threshold angle θth. Further, it is assumed that the above conditions 1 to 4 are satisfied. In this case, the ECU20 executes the collision control when the second collision condition is satisfied.

### (Specific Operation)

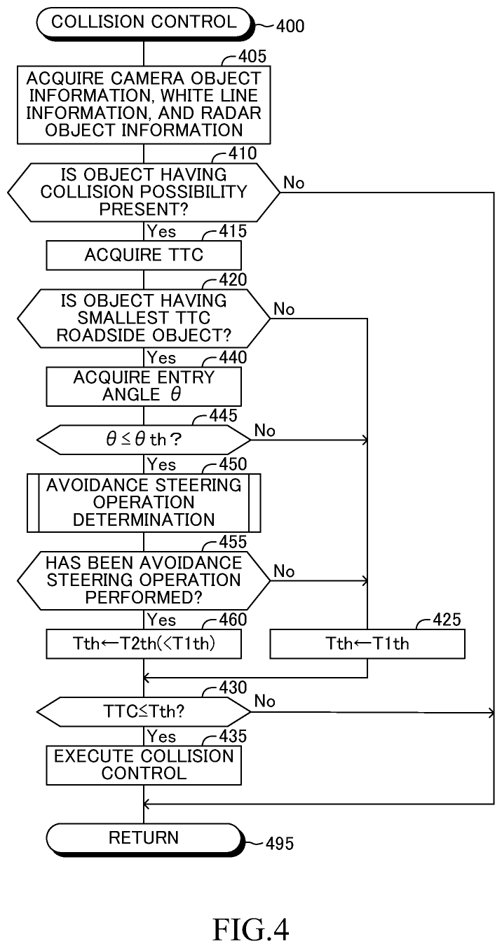

The CPU of the ECU20 executes a routine illustrated by a flowchart in FIG. 4 every time a predetermined time elapses.

### <Collision Control Routine>

When an appropriate time point has arrived, the CPU starts a process from step 400 of FIG. 4 and executes steps 405 and 410.

Step 405: The CPU acquires the camera object information and the white line information from the camera 22, and acquires the radar object information from the millimeter wave radar 24.

Step 410: The CPU determines whether or not the object that may collide with the vehicle VA (the object that has a collision possibility) is present based on the traveling TD of the vehicle VA.

When the object having the collision possibility is present (step 410 “Yes”), the CPU executes steps 415 and 420.

Step 415: The CPU acquires the TTC of the object having the collision possibility. Specifically, the CPU acquires the TTC by dividing the distance to the object by the relative speed Vr of the object.

Step 420: The CPU determines whether or not the object having the smallest TTC is the roadside object OB.

When the object having the smallest TTC is not the roadside object OB (step 420 “No”), the CPU executes steps 425 and 430.

Step 425: The CPU sets a threshold time Tth to the first threshold time T1th.

Step 430: The CPU determines whether or not the TTC is equal to or less than the threshold time Tth.

When the TTC is equal to or less than the threshold time Tth (step 430 “Yes”), the CPU executes the collision control at step 435. After that, the process proceeds to step 495, and the CPU terminates the present routine tentatively.

When the object having the smallest TTC is the roadside object OB (step 420 “Yes”), the CPU executes steps 440 and 445.

Step 440: The CPU acquires an entry angle θ.

Step 445: The CPU determines whether or not the entry angle θ is equal to or less than the threshold angle θth.

When the entry angle θ is equal to or less than the threshold angle θth (step 445 “Yes”), the CPU executes steps 450 and 455.

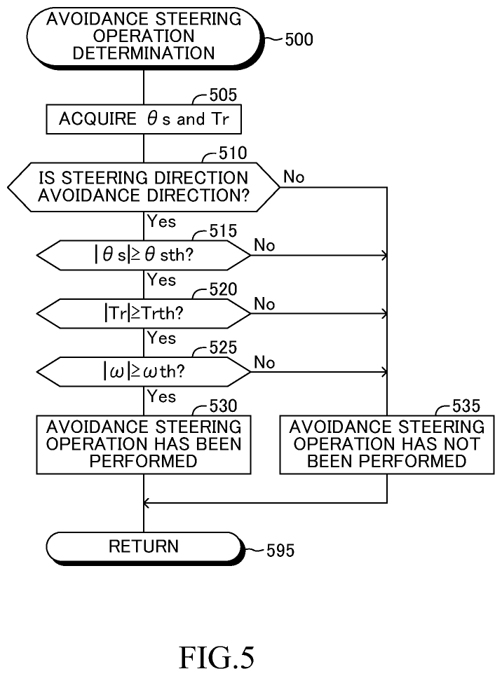

Step 450: The CPU executes an avoidance steering operation determination subroutine for determining whether or not the driver has performed the avoidance steering operation. The avoidance steering operation determination subroutine will be described with reference to FIG. 5.

Step 455: The CPU determines whether or not it is determined in step 450 that the avoidance steering has been performed.

When it is determined that the avoidance steering operation has been performed (step 455 “Yes”), the CPU sets the threshold time Tth to “the second threshold time T2th set to a value smaller than the first threshold time T1th” in step 460. Thereafter, the process proceeds to step 430.

When the entry angle θ is greater than the threshold angle θth (step 445 “No”) or when the avoidance steering operation has not been performed (step 455 “No”), the process proceeds to step 425.

When the object having the collision possibility is not present (step 410 “No”) or when the TTC is greater than the threshold time Tth (step 430 “No”), the process proceeds to step 495 so that the CPU terminates the present routine tentatively.

### <Avoidance Steering Operation Determination Subroutine>

When the process proceeds to step 450 of FIG. 4, the CPU start the process from step 500 of FIG. 5, and executes steps 505 and 510.

Step 505: The CPU acquires the steering angle θs and the steering torque Tr based on the detected values from the steering angle sensor 28 and the steering torque sensor 29 respectively.

Step 510: The CPU determines whether or not the steering operation to an avoidance direction has been performed based on the steering angle θs.

When the steering operation to the avoidance direction has been performed (step 510 “Yes”), in step 515, the CPU determines whether or not the magnitude of the steering angle θs is equal to or greater than the threshold angle θsth.

When the magnitude of the steering angle θs is equal to or greater than the threshold angle θsth (step 515 “Yes”), in step 520, the CPU determines whether or not the magnitude of the steering torque Tr is equal to or greater than the threshold torque Trth.

When the magnitude of the steering torque Tr is equal to or greater than the threshold torque Trth (step 520 “Yes”), the CPU determines in step 525 whether or not the magnitude of the steering angular velocity ω is equal to or greater than the threshold angular velocity ωth. The CPU acquires the steering angular velocity ω by differentiating the steering angle θs with time.

When the magnitude of the steering angular velocity ω is equal to or greater than the threshold angular velocity ωth (step 525 “Yes”), the CPU determines in step 530 that the avoidance steering operation has been performed. Thereafter, the process proceeds to step 595, and the CPU terminates the present routine tentatively.

When the steering operation to the avoidance direction has not been performed (step 510 “No”), when the magnitude of the steering angle θs is less than the threshold angle θsth (step 515 “No”), when the magnitude of the steering torque Tr is less than the threshold torque Trth (step 520 “No”), or when the magnitude of the steering angular velocity ω is less than the threshold angular velocity ωth (step 525 “No”), the CPU determines that the avoidance steering operation has not been performed in step 535. After that, the process proceeds to step 595, and the CPU terminates the present routine tentatively.

As described above, in a case where at least one of the angle condition and the steering condition is not satisfied and the object having the collision possibility is the roadside object OB, the ECU20 executes the collision control when the first collision condition is satisfied. In a case where both the angle condition and the steering condition are satisfied, the ECU20 executes collision control when the second collision condition is satisfied. Accordingly, it is possible to decrease the possibility that the unnecessary collision control for the roadside object OB is executed. Furthermore, it is possible to increase the possibility that the collision control required for the roadside object OB is reliably executed.

Generally, when the driver performs the avoidance steering operation, the driver steers the steering wheel 28a so that the magnitude of the steering torque Tr and the steering angular velocity ω suddenly increases. When the driver performs a normal steering operation, the driver does not steer the steering wheel 28a so that the magnitude of the steering torque Tr and the steering angular velocity ω suddenly increases. Therefore, the steering condition is satisfied when both the condition that the magnitude of the steering angle θs is equal to or larger than the threshold angle θsth and the condition that the magnitude of the steering torque Tr and the steering angular velocity ω is equal to or larger than the threshold are satisfied. Accordingly, the ECU20 can accurately determine that the avoidance steering operation has been performed.

### (Modification)

The roadside object OB may be present in the median strip of the road but not in the roadside. The roadside object OB is not limited to a guardrail, a wall, or the like. The roadside object OB may be a street tree or the like.

When both the condition 1 and the condition 2 are satisfied and at least one of the condition 3 and the condition 4 is satisfied, the ECU20 may determine that the steering condition is satisfied.

The ECU20 may use the distance to the object instead of the TTC as an index indicating the possibility of colliding with the object.

When both the angle condition and the steering condition are satisfied, the ECU20 may determine, instead of determining whether or not the TTC is equal to or less than the threshold time Tth set to the second threshold time T2th, whether or not a multiplication value acquired by multiplying the TTC by a “gain for increasing the TTC” is equal to or less than the threshold time Tth. As a result, the collision condition of when both the angle condition and the steering condition are satisfied is more difficult to be satisfied than the collision condition of when at least one of the angle condition and the steering condition is not satisfied.

The collision control is not limited to the deceleration control. The ECU20 may execute, as the collision control, a display control for causing the display device 52 to display a warning screen for calling the driver's attention to the object satisfying the first collision condition or the second collision condition.

The support apparatus 10 may be applied vehicles such as an engine vehicle, a HEV (Hybrid Electric Vehicle), a PHEV (Plug-in Hybrid Electric Vehicle), a FCEV (Fuel Cell Electric Vehicle), and a BEV (Battery Electric Vehicle).

The present disclosure can also be expressed as a non-transitory computer-readable storage medium where a program for realizing a function of the support apparatus 10 is stored.

What is claimed is:

1. A driving support apparatus comprising:
a sensor configured to detect an object; and
a controller configured to execute a collision control for avoiding a collision between a vehicle and the object or reducing a damage caused by the collision when the object satisfies a first collision condition,
wherein,
the controller is further configured to:
determine whether or not the object satisfies a second collision condition which is more difficult to be satisfied than the first collision condition when both an angle condition and a steering condition are satisfied in a case where the object is a three-dimensional object which is in a roadside or a median strip of a road on which the vehicle is traveling, the angle condition being a condition that an entry angle formed by a traveling direction of the vehicle and the three-dimensional object is equal to or smaller than a threshold angle, the steering condition being a condition for determining that a driver performs a steering operation for avoiding the collision between the vehicle and the three-dimensional object; and
execute the collision control when the three-dimensional object satisfies the second collision condition.

2. The driving support apparatus according to claim 1,
wherein,
the controller is further configured to:
acquire a steering angle of a steering wheel, and at least one of a steering torque of the steering wheel and a steering angular velocity of the steering wheel;
determine that the steering condition is satisfied when all of a first condition, a second condition, and a third condition is satisfied,
the first condition being a condition that the steering wheel is steered to a direction of decreasing the entry angle,
the second condition being a condition that a magnitude of the steering angle is equal to or greater than a threshold angle;
the third condition being a condition that a magnitude of at least one of the steering torque and the steering angle is equal to or greater than a steering threshold.

3. The driving support apparatus according to claim 1,
wherein,
the controller is further configured to:
determine that the object satisfies the first collision condition when a collision index value is equal to or smaller than a first collision threshold, the collision index value indicates that a possibility that the vehicle collides with the object is higher as the collision index value is smaller; and
determine that the object satisfies the second collision condition when the collision index value is equal to or smaller than a second collision threshold which is preset to a value smaller than the first collision threshold.

4. A driving support method for causing a computer installed on a vehicle to execute a collision control for avoiding a collision between the vehicle and an object detected by a sensor or reducing a damage caused by the collision when the object satisfies a first collision condition, comprising:
a first step of causing the computer to determine whether or not the object satisfies a second collision condition which is more difficult to be satisfied than the first collision condition when both an angle condition and a steering condition are satisfied in a case where the object is a three-dimensional object which is in a roadside or a median strip of a road on which the vehicle is traveling, the angle condition being a condition that an entry angle formed by a traveling direction of the vehicle and the three-dimensional object is equal to or smaller than a threshold angle, the steering condition being a condition for determining that a driver performs a steering operation for avoiding the collision between the vehicle and the three-dimensional object; and
a second step of causing the computer to execute the collision control when the object satisfies the second collision condition.

5. A non-transitory computer-readable storage medium storing a program for causing a computer installed on a vehicle to execute a collision control for avoiding a collision between the vehicle and an object detected by a sensor or reducing a damage caused by the collision when the object satisfies a first collision condition,
the program causing the computer to implement processes of:
determining whether or not the object satisfies a second collision condition which is more difficult to be satisfied than the first collision condition when both an angle condition and a steering condition are satisfied in a case where the object is a three-dimensional object which is in a roadside or a median strip of a road on which the vehicle is traveling, the angle condition being a condition that an entry angle formed by a traveling direction of the vehicle and the three-dimensional object is equal to or smaller than a threshold angle, the steering condition being a condition for determining that a driver performs a steering operation for avoiding the collision between the vehicle and the three-dimensional object; and
executing the collision control when the object satisfies the second collision condition.
